(19) United States
(12) Patent Application Publication
(10) Pub. No.: US 2005/0048438 A1
(43) Pub. Date: Mar. 3, 2005

(54) Case for retaining dental cleaning tools therein

(76) Inventor: Patrick Gwen, Houston, TX (US)

Correspondence Address: John S. Egbert;Harrison & Egbert, 7th Floor, 412 Main Street, Houston, TX, 77002, US

(21) Appl. No.: 10/647,128

(22) Filed: Aug. 25, 2003

(51) Int. Cl. A61C 3/00

(52) U.S. Cl. 433/141

(57) ABSTRACT

A dental tool apparatus has a case, a first cleaning tool and second cleaning tool. The first and second cleaning tools are pivotally mounted in the case so as to be movable between a first position within the case to a second position extending outwardly of the case. A closure member is pivotally connected to the case so as to be movable between a covering position covering the cleaning tools within the case and an open position allowing the cleaning tools to move from the first position to the second position.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to dental tools. More particularly, the present invention relates to cases that retain the dental tools therein. Additionally, the present invention relates to toothpicks and tongue scrapers that are pivotally retained within a case for easy transportability.

### BACKGROUND OF THE INVENTION

A variety of implements can be used for the cleaning of the mouth. Conventionally, toothbrushes are used for the specific cleaning of the teach. Toothbrushes are often used in association with toothpaste so as to assure clean teeth and to prevent dental decay. In other circumstances, various types of toothpicks are used for the purpose of cleaning the interstices between the teeth. It has been known that it is important to prevent gum disease from affecting the integrity of the teeth. As such, various types of toothpicks and dental floss so as to clean these interstices between the teeth. Food particles can be removed which would otherwise be inaccessible by the toothbrushes. Toothpicks come in a wide variety of configurations and shapes. Some toothpicks are designed so as to be directly introduced into the spaces between the teeth. Other toothpicks are designed so as to dig into the gum area adjacent to the roots of the teeth.

Tongue scrapping is carried out in many areas of the world for the cleaning of the mouth and dental area. In particular, the scraping of tongues is carried out so as to volatile sulfur compounds. The accumulation of bacterias the most common cause of bad breath, affecting up to 85% of halitosis suffers. Tongue scrapping is recommended by the American Dental Association and by dental professionals nationwide for the treatment of chronic halitosis.

To carry out a full and effective cleaning of the teeth subsequent to brushing, it would be desirable to have both toothpicks and tongue scrapers conveniently available. Unfortunately, each of these items must be carried separately by the individual. As a result, the toothpicks can become lost or damaged and the tongue scraper inaccessible. The inconvenience of carrying these items separately often works against the proper cleaning of the teeth and tongue. It would be desirable to include various tools within a single container or case so that proper dental hygiene can be promoted.

It is an object of the present invention to provide a dental tool apparatus which allows a variety of dental tools to be conveniently carried within a carrying case.

It is another object of the present invention to provide a dental tool apparatus which retains toothpicks and tongue cleaners therein.

It is another object of the present invention to provide a dental tool apparatus which allows the dental tools to be moved between a stowed position to a position ready for use.

It is another object of the present invention to provide a dental tool apparatus which provides alternative forms of toothpicks for use in prying and digging actions.

It is a further object of the present invention to provide a dental tool apparatus includes a tongue scraper that effective cleans the surfaces of the tongue in a very efficient manner.

It is still another object of the present invention to provide a dental tool apparatus which is easy to use and relatively inexpensive.

These and other objects and advantages of the present invention will become apparent from a reading of the attached specification and appended claims.

### BRIEF SUMMARY OF THE INVENTION

The present invention is a dental tool apparatus that comprises a case, a first cleaning tool and second cleaning tool. The first and second cleaning tools are pivotally mounted in the case so as to be movable between a first position within the case to a second position extending outwardly of the case. In a preferred embodiment of the present invention, a third cleaning tool is also pivotally mounted in the case so as to be movable between a first position within the case to a second position extending outwardly of the case. The first and second cleaning tools are arranged in side-by-side relation within the case when in the first position.

In the present invention, a closure member is pivotally connected to the case. The closure member is movable between a covering position covering the tools within the case and an open position allowing the cleaning tools to move from the first position to the second position. The closure member retains at least one of the cleaning tools in the second position when the closure member is in the covering position. The first cleaning tool has a flap extending outwardly of a surface thereof. The closure member has a surface abutting the flap when the closure member is in the covering position.

Each of the cleaning tools has a lever member extending outwardly of an end of the case when the cleaning tools are in the first position. These lever members of the cleaning tools are angularly offset from each other. The case an abutment member extending thereacross. The lever member of at least one of the cleaning tools is in contact with the abutment member when the cleaning tool is in the second position. Each of the cleaning tools has a notch formed on another surface thereof. The surface of the closure member is received within this notch when the closure member is in the covering position. The case has an axle extending theracross. Each of the cleaning tools is pivotally mounted coaxially on the axle.

In the preferred form of the present invention, the first cleaning tool is a tongue scraper and the second cleaning tool is a toothpick. Where a third cleaning tool is used, the third cleaning tool is a toothpick of a different configuration than that of the second cleaning tool. The tongue scraper has a blade at an end thereof and a plurality of truncated tubes extending outwardly of a surface thereof adjacent to the blade.

### BRIEF DESCRIPTION OF THE SEVERAL VIEWS OF THE DRAWINGS

FIG. 1 is a side elevational view of the dental tool apparatus of the present invention showing the tongue scraper extending outwardly of the case and the toothpicks retained within the case.

FIG. 2 is side elevational view of the apparatus of the present invention with all of the cleaning tools retained within the case.

FIG. 3 is a side elevational view of the apparatus of the present invention showing the closure member in an open position and one of the toothpicks extending outwardly of the case.

FIG. 4 is back view of the apparatus of the present invention.

FIG. 5 is a side elevational view of the apparatus of the present invention showing a singular tongue scraper extending outwardly of the case.

FIG. 6 is a side elevational view of the apparatus of the present invention showing one form of the toothpick singularly extending outwardly of the case.

FIG. 7 is a side elevational view of the apparatus of the present invention showing another form of the toothpick extending outwardly of the case.

### DETAILED DESCRIPTION OF THE INVENTION

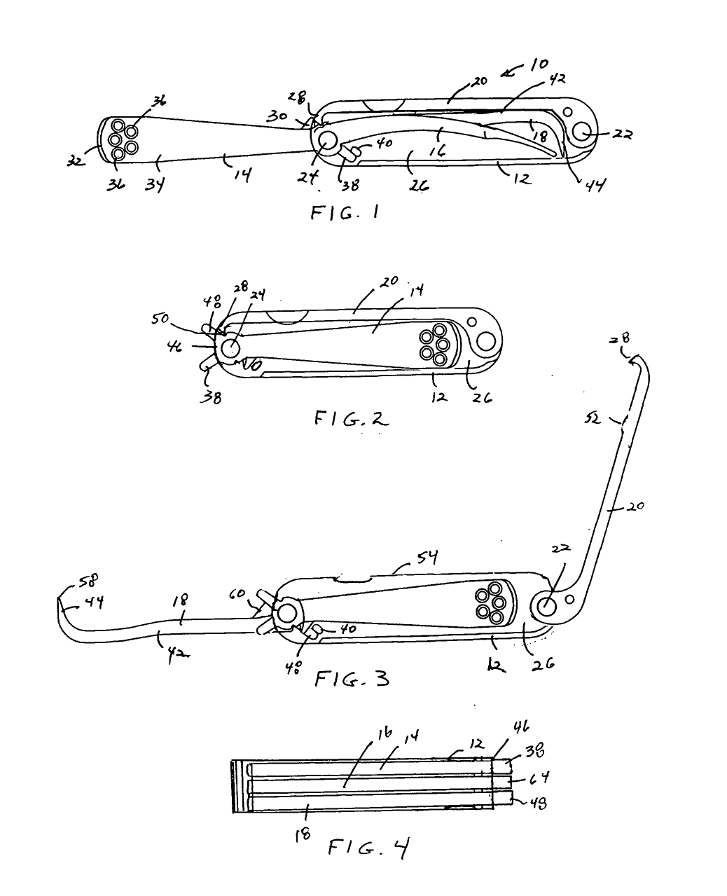

Referring to FIG. 1, there is shown the dental tool apparatus 10 in accordance with the preferred embodiment of the present invention. The dental tool apparatus 10 includes a case 12 having a first cleaning tool 14 extending outwardly therefrom, a second cleaning tool 16 positioned within the case 12 and a third cleaning tool 18 retained within the case. A closure member 20 is pivotally connected at axle 22 to the case 12 so as to allow the closure member 20 to be movable between a covering position (shown in FIG. 1) to an open position (shown in FIG. 3).

In FIG. 1, it can be seen that each of the cleaning tools 14, 16 and 18 are pivotally mounted to another axle 24 within the case 12. Each of the cleaning tools 14, 16 and 18 are movable between a first position within the case (illustrated by the position of cleaning tools 16 and 18) to a second position extending outwardly of the case (illustrated by the position of the cleaning tool 14). The case 12 has an interior volume 26 of a suitable size for retaining the cleaning tools 14, 16 and 18 therein. The closure member 20 covers the interior volume 26 so as to retain the cleaning tools 16 and 18 therein. An end surface 28 of the closure member 20 is illustrated as against a flap 30 extending outwardly of a surface of the cleaning tool 14 so as to retain the cleaning tool 14 in a position extending outwardly of the case 12. In the present invention, each of the case 12, the closure member 20, and the cleaning tools 14, 16 and 18 are formed of polymeric materials in an injection molding process.

In FIG. 1, the cleaning tool 14 is a tongue scraper device having a blade 32 at one end thereof. The blade 32 extends outwardly of the surface 34 of the cleaning tool 14 so as to provide a “scraping” action against the surface of the tongue. A plurality of truncated tubes 36 also extend outwardly of the surface 34 of cleaning tool 14 generally adjacent to the position of the blade 32. The plurality of truncated tubes 36 are arranged so as to maximize the surface area of contact between the surfaces of the tongue scraper of cleaning tool 14 with the surfaces of the tongue. Holes can be formed through the surface 34 within the interior of the tubes 36 so as to allow for circulation of saliva therethrough.

The tongue scraper 14 is pivotally mounted about axle 24 of case 12. The cleaning tool 14 is retained in this outwardly extending position by having a lever member 38 in contact with an abutment member 40 extending across the interior volume 26 of case 12. Simultaneously, the surface 28 of closure member 20 will provide a contact against the flap 30 extending outwardly of the cleaning tool 14. As such, the relationship between the closure member 20 and the pivotal orientation of the cleaning tool will fixedly retain the tongue scraper in its outwardly extending position.

The second cleaning tool 16 is also pivotally mounted in coaxial relationship to the first cleaning tool 14. The second cleaning tool 16 is in the form of a curved toothpick of generally longitudinal orientation. The curved toothpick 16 is the type of toothpick that is suitable for prying cleaning action. As such, the toothpick shown by the cleaning tool 16 is particularly applicable to the removal of debris from between the user's teeth. The third cleaning tool 18 is in the form of another type of toothpick. The third cleaning tool 18 has a generally linear portion 42 and a transverse portion 44. The transverse portion 44 is pointed and curves so as to be suitable for digging action around the gums of the user. As such, the cleaning tools 16 and 18 provide for different functions during the cleaning of the teeth of the user. The third cleaning tool 18 is also coaxially pivotally mounted about axle 24.

FIG. 2 shows each of the cleaning tools 14, 16 and 18 as retained within the interior volume 26 of case 12. Importantly, it can be seen that the first cleaning tool 14 has lever member 38 extending outwardly of the end of case 12. One of the other cleaning tools 16 and 18 also has a lever member 48 extending outwardly of the end 46 of case 12. Lever member 38 is angularly offset relative to axle 24 from lever member 48. As such, the orientation of the lever members 38 and 48 allows the user to easily pick and choose between the cleaning tools that are desired. In FIG. 2, it can be seen that all of the cleaning tools 14, 16 and 18 are proper stowed within the interior volume 24. The closure member 20 entirely covers the interior volume 26 of case 12 so as to stow the cleaning tools 14, 16 and 18 hygienically. Importantly, it can be seen that the end surface 28 of the closure member 20 is received within a notch 50 formed on the surface of the first cleaning tool 14. Notch 50 is also found about the axle portions of each of the other cleaning tools 16 and 18. As such, these notches 50 will form a seat for retaining the closure member 20 in its closed portion covering the interior volume 26.

In FIG. 3, it can be seen that the closure member 20 is pivoted about axle 22 so as to move from its closed portion (as shown in FIGS. 1 and 2) to an open position. When the closure member 20 is in this open position, it is possible to move the cleaning tools 14, 16 and 18 from their stowed position within the interior volume 26 of case 12 to their outwardly extending position. In FIG. 3, it can be seen that the third cleaning tool 18 is illustrated as extending out of the case 12. The closure member 20 has a grasping portion 52 formed on a surface thereof so as to allow the closure member 20 to be easily lifted from the surface 54 of case 12. Also, in FIG. 3, it can be seen that the lever member 48 of the cleaning tool 18 is in surface-to-surface contact with the abutment member 40. As such, the abutment member 40 will serve to fixedly retain the cleaning tool 18 in its outwardly extending position. The cleaning tool 18 is the form of a toothpick having the longitudinal portion 42 and a transverse portion 44. The point 58 at the end of transverse portion 44 is suitable for digging and cleaning action. The cleaning tool 18 also has a flap 60 extending outwardly of a surface thereof. Flap 60 is similar to the flap 30 of the cleaning tool 14. Flap 60 provides a surface against which the end surface 28 of closure member 20 abuts so as to properly fix the position of cleaning tool 18.

In FIG. 4, it can be seen that the case 12 has each of the cleaning tools 14, 16 and 18 in side-by-side relationship therein. Conventionally, the case 12 will be a transparent plastic material. Each of the lever members 38, 64 and 48 extend outwardly of the end 46 of case 12. Lever member 64 is angularly offset from lever members 38 and 48 so as to allow for easy finger access to each of the lever members 38, 64 and 48.

FIGS. 5-7 show each of the cleaning tools 14, 18 and 16, respectively, as extending outwardly of the respective cases 12. It is important to note that within the concept of the present invention, the case 12 can retain a single cleaning tool, a pair of cleaning tools or all three cleaning tools. The illustrations of FIGS. 5-7 simply show the manner in which separate tools can be utilized in association with the case 12.

In FIG. 5, it can be seen that the tongue scraper cleaning tool 14 has been removed from the interior volume 26 of case 12. The tongue scraper cleaning tool 14 is of an identical configuration to that shown in FIG. 1. Importantly, it can be seen that the cleaning tool 14 has a flap 30 extending outwardly of a surface thereof. The end surface 28 of closure member 20 abuts the flap 30 so as to fix the position of the tongue scraper 14 outwardly of the case 12. Similarly, the lever member 38 is illustrated as abutting the abutment member 40 in the interior volume 26 of case 12. In this arrangement, the tongue scraper 14 is its proper position for use.

FIG. 6 shows toothpick cleaning tool 18 as extending outwardly of the interior volume 26 of case 12. The cleaning tool 18 is of an identical configuration to the cleaning tool 18, as shown in FIG. 3. Importantly, in FIG. 6, it can be seen that the flap 60 extends outwardly of the cleaning tool 18. The end surface 28 of closure member 20 abuts the flap 60. As such, the cleaning tool 18 is fixed in its outwardly extending position. Additionally, the lever member 48 is rotated about the axle 24 so as to abut the abutment member 40 in the interior volume 26 of case 12.

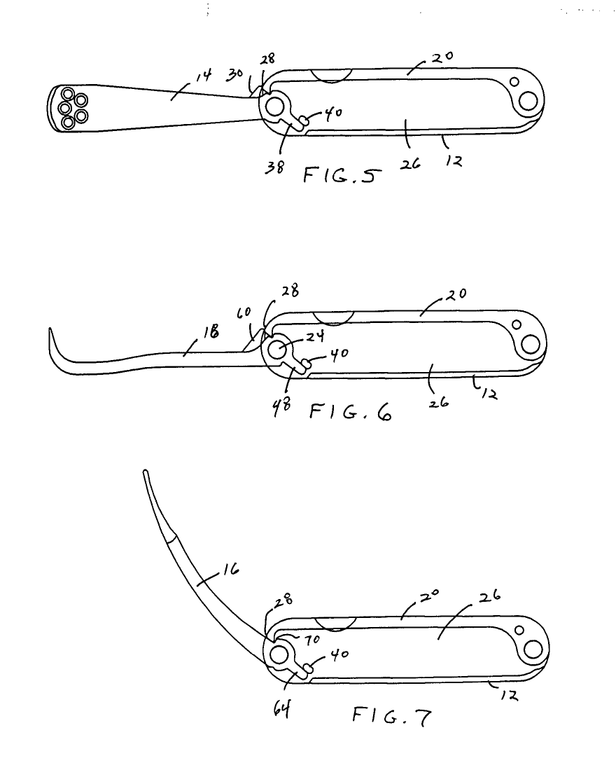

FIG. 7 shows the other form of toothpick cleaning tool 16 in its position extending outwardly of the case 12. Since the toothpick 16 is of a different configuration than that of the toothpick 18, the toothpick 16 will be retained in a slightly different position than that of toothpick 18. Once again, the toothpick cleaning tool 16 has lever member 64 extending outwardly therefrom so as to abut abutment member 40 within the interior volume 26 of case 12. The end surface 28 of closure member 20 is received within a notch 70 formed on the surface of the cleaning tool 16. In actual use, the cleaning tool 16 will be grasped by the fingers of the user so as to facilitate proper manipulation. The angular orientation of the toothpick cleaning tool 16 is ergonomically preferable for the prying action imparted into the interstices between the teeth.

The present invention provides a convenient and inexpensive dental cleaning apparatus. When not in use, the closure member neatly contains the cleaning tools within the interior of the case so as to prevent contamination with external surfaces. The closure member works syngeristically with the various tools so as to fix the tools in their desired positions. The lever members facilitate the ability to properly manipulate each of the cleaning tools for use.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

1. A dental tool apparatus comprising:
a case;
a first cleaning tool pivotally mounted in said case so as to be movable between a first position within said case to a second position extending outwardly of said case; and
a second cleaning tool pivotally mounted in said case so as to be movable between a first position within said case to a second position extending outwardly of said case.

2. The apparatus of claim 1, further comprising:
a third cleaning tool pivotally mounted in said case so as to be movable between a first position within said case to a second position extending outwardly of said case.

3. The apparatus of claim 1, said first cleaning tool and said second cleaning tool being in side-by-side relationship within said case in said first position.

4. The apparatus of claim 1, further comprising:
a closure member pivotally connected to said case, said closure member movable between a covering position covering said first and second cleaning tools within said case and an open position allowing said first and second cleaning tools to move from said first position to said second position.

5. The apparatus of claim 4, said closure member retaining at least one of said first and second cleaning tools in said second position when said closure member is in said cover position.

6. The apparatus of claim 5, said first cleaning tool having a flap extending outwardly of a surface thereof, said closure member having a surface abutting said flap when said closure member is in said covering position.

7. The apparatus of claim 1, said first cleaning tool having a lever member extending outwardly of said case when said first cleaning tool is in said first position, said second cleaning tool having a lever member extending outwardly of and end of said case when said second cleaning tool is in said first position.

8. The apparatus of claim 7, said lever member of said first cleaning tool being angularly offset from said lever member of said second cleaning tool.

9. The apparatus of claim 7, said case having an abutment member extending thereacross, said lever member of said first cleaning tool contacting said abutment member when in said second position.

10. The apparatus of claim 6, said first cleaning tool having a notch formed on a surface thereof, said surface of said closure member received within said notch when said closure member is in said covering position.

11. The apparatus of claim 1, said first cleaning tool being a tongue scraper, said second cleaning tool being a toothpick.

12. The apparatus of claim 11, said tongue scraper having a blade at an end thereof and a plurality of truncated tubes extending outwardly of a surface thereof adjacent said blade.

13. The apparatus of claim 1, said case having an axle extending thereacross, said first and second cleaning tools being pivotally mounted coaxially on said axle.

14. A dental tool apparatus comprising:
a case;
a tongue scraper pivotally mounted in said case so as to be movable between a first position within said case to a second position extending outwardly of said case; and
a first toothpick pivotally mounted in said case so as to be movable between a first position within said case to a second position extending outwardly of said case.

15. The apparatus of claim 14, further comprising:
a second toothpick pivotally mounted in said case so as to be movable between a first position within said case to a second position extending outwardly of said case, said first toothpick having a different configuration than said second toothpick.

16. The apparatus of claim 14, further comprising:
a closure member pivotally connected to said case, said closure member movable between a covering position covering said tongue scraper and said first toothpick within said case and an open position allowing said tongue scraper and said first toothpick to move from said first position to said second position.

17. The apparatus of claim 14, said tongue scraper having a blade at an end thereof and a plurality of truncated tubes extending outwardly of a surface thereof adjacent said blade.

18. A dental tool apparatus comprising:
a case having an interior volume;
a first cleaning tool pivotally mounted in said case so as to movable between a first position within said case to a second position extending outwardly of said case; and
a closure member pivotally connected to said case, said closure member movable between a covering position covering said first and second cleaning tools within said case and an open position allowing said first and second cleaning tools to move from said first position to said second position.

19. The apparatus of claim 18, said closure member retaining at least one of said first and second cleaning tools in said second position when said closure member is in said cover position.

20. The apparatus of claim 19, said first cleaning tool having a flap extending outwardly of a surface thereof, said closure member having a surface abutting said flap when said closure member is in said covering position, said first cleaning tool having a notch formed on another surface thereof, said surface of said closure member received within said notch when said closure member is in said covering position.
